(19) United States
(12) Patent Application Publication
(10) Pub. No.: US 2022/0018130 A1
(43) Pub. Date: Jan. 20, 2022

(54) METHOD OF PRODUCING PRECAST BUILDING PRODUCTS

(71) Applicant: SWISS INVESTMENTS AUSTRALIA PTY LTD, Moss Vale, NSW (AU)

(72) Inventor: Geoffrey A. Kull, Moss Vale, NSW (AU)

(73) Assignee: SWISS INVESTMENTS AUSTRALIA PTY LTD, Moss Vale, NSW (AU)

(21) Appl. No.: 17/427,333

(22) PCT Filed: Jun. 19, 2020
(86) PCT No.: PCT/AU2020/050629

§ 371 Date: Jul. 30, 2021

(30) Foreign Application Priority Data
Jun. 20, 2019 (AU) 2019902163

(51) Int. Cl. E04C 2/52; E04C 2/04; E04C 2/06; E21D 11/08; B28B 23/22; B28B 23/02; B28B 7/42; B28B 7/22; B28B 7/14; B28B 7/02; B28B 1/093; B28B 1/08

(52) U.S. Cl. CPC E04C 2/525; E04C 2/044; E04C 2/06; E21D 11/08; B28B 23/22; B28B 1/084; B28B 7/42; B28B 7/22; B28B 7/14; B28B 7/02; B28B 1/0935; B28B 23/022

(57) ABSTRACT

An aspect concerns a method (10) of producing a precast building product. The method (10) includes providing a mould (26) to receive a pourable building substance to be cured. The method further includes the steps of pouring the building substance into the mould and allowing the poured building substance to cure inside the mould to form a sold mass body. The method further includes providing a wire-cutting assembly operatively associated with the mould and cutting the solid mass body inside the mould into separate building products.

### FIELD

The invention concerns a method of producing precast building products, particularly but not exclusively, precast concrete panels for use in housing, commercial, factory, agricultural and mining applications.

### BACKGROUND

Precast concrete products are produced at a precast plant by casting concrete in reusable moulds and allowing the concrete to cure in a controlled environment. Concrete strength and quality of a precast concrete product are contingent, amongst other factors, upon the curing process. By curing concrete in a tightly controlled environment there can be confidence in the strength and consistency of the products so manufactured. The produced concrete products can then be transported on flatbed trucks to a construction site to be lifted (“tilt up”) into a desired position. This method of construction differs from standard concrete (or in-situ concrete) which is poured into forms at the construction site and allowed to cure on-site.

Drawbacks associated with in-situ curing is that it is both time and space intensive to construct on-site formwork required for onsite concrete forming. Also, it requires construction teams to engage in weather prediction to identify the required conditions for curing. Scheduling in the construction industry tends to be delicately balanced and unexpected delay of even a day could send a construction project over budget. Precast concrete products address those concerns by avoiding the logistics of on-site curing.

Using precast concrete also enables optimum usage of material. The reason for this is that due to the precision of precast concrete material, wastage is limited. It tends to be far harder to achieve this on-site as the labour inefficiency associated with concrete preparation motivates contractors to mix more concrete than required as a precaution of not having a sufficient amount of concrete available.

Despite the various benefits of employing precast concrete panels they are normally used only in industrial and commercial buildings. The reason for this is that existing precast concrete panels tend to be grey and unsightly and, therefore, not fit for use in buildings where aesthetics are key considerations. As such architects tend to steer clear of employing precast concrete panels in designing buildings.

### Object

It is an object of the present invention to provide an alternative method of producing precast building products/panels for such products/panels displaying aesthetic features.

### SUMMARY

According to a first aspect of the present invention there is disclosed herein a method of producing a precast building product, the method including the steps of:

providing a mould to receive a pourable building substance to be cured; pouring the building substance into the mould; allowing the poured building substance to cure inside the mould to form a sold mass body;

providing a wire-cutting assembly operatively associated with the mould; and cutting the solid mass body inside the mould into separate building products.

Preferably the building substance includes (i) concrete, or (ii) a building composite including gravels.

Preferably the method includes the step of vibrating the poured building substance.

Preferably the method includes the step of locating reinforcing within the mould prior to the step of pouring the building substance into the mould.

Preferably the reinforcing comprises a plurality of mesh cages.

Preferably the reinforcing has an electronic sensor attached thereto.

Preferably the reinforcing supports a plurality of elongate cooling conduits.

Preferably the method includes the step of feeding cooling liquid through the cooling conduits.

Preferably the method includes the step of insulating the mould.

### BRIEF DESCRIPTION OF THE DRAWINGS

Preferred embodiments of the invention will be described hereinafter, by way of examples only, with reference to the accompany drawings, wherein:

FIG. 1 is a diagrammatic illustration of a production line for effecting an embodiment method of producing precast building products;

FIG. 2 is a diagrammatic side view of an embodiment mould for use in the embodiment method of producing precast concrete products;

FIG. 3 is a plan view of the mould of FIG. 2;

FIG. 4 is an end view of the mould of FIG. 2;

FIG. 5 is a side view of a precast concrete body produced by the method;

FIG. 6 is a plan view of the concrete body of FIG. 5;

FIG. 7 is an end view of the concrete body of FIG. 5;

FIG. 8 is a diagrammatic illustration of a surface finish obtained by the embodiment method;

FIG. 9 is a diagrammatic illustration of a foyer sign obtained by the embodiment method;

FIG. 10 is a diagrammatic illustration of a precast concrete product for use in a residential housing application obtained by the embodiment method;

FIG. 11 is a diagrammatic illustration of an aesthetic feature obtained by the embodiment method;

FIG. 12 is a diagrammatic illustration of a precast concrete panel obtained by the embodiment method employed at a mining entrance;

FIG. 13 is a diagrammatic illustration of a precast concrete panel for a mining application;

FIG. 14 is a diagrammatic side view of a second embodiment mould for use in a second embodiment method of producing precast concrete products;

FIG. 15 is an end view of the mould of FIG. 14;

FIG. 16 is a plan view of the mould of FIG. 14 having an open top;

FIG. 17 is a diagrammatic perspective view of an embodiment decorative concrete product including an embodiment decorative insert; and

FIG. 18 is a diagrammatic end view of a mould for use in producing the decorative insert.

### DESCRIPTION OF PREFERRED EMBODIMENTS

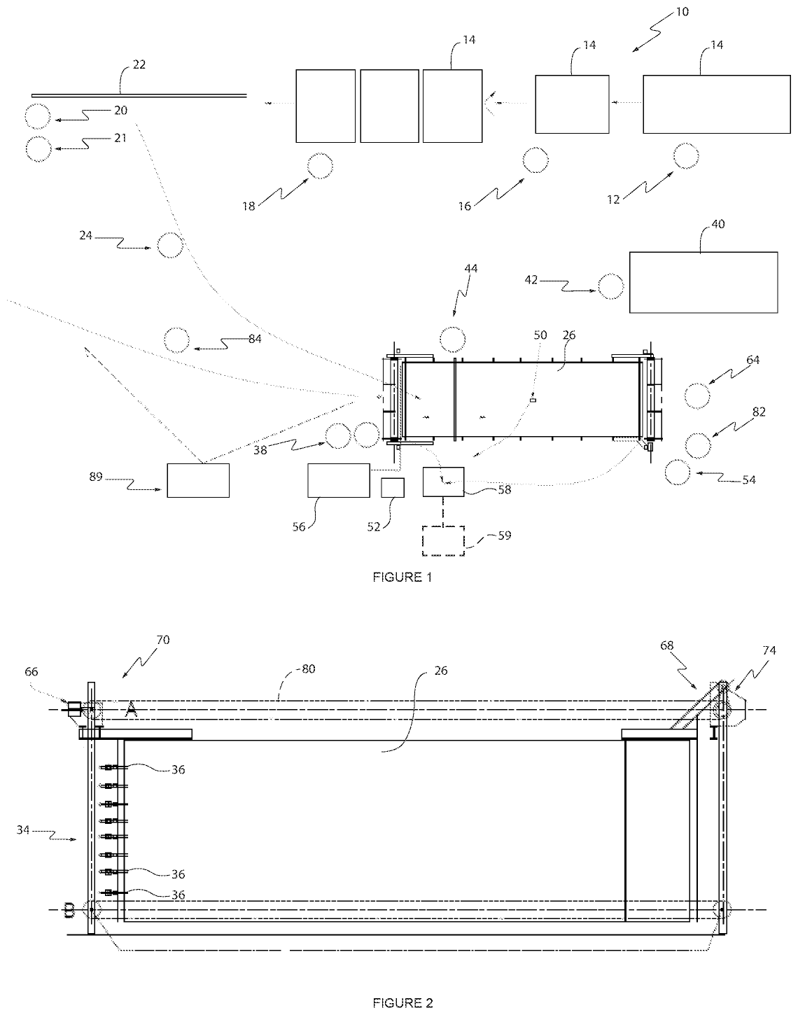

FIG. 1 is a diagrammatic illustration of a production line employing an embodiment method of producing precast building products. The embodiment method is generally indicated with the reference numeral 10 and is here employed to manufacture precast concrete panels. It will of course be appreciated that the method could be employed to produce a range of precast building products for example precast building products produced from a building composite including gravels.

Step 1, reference numeral 12, of the embodiment method 10 includes that there is provided a sheet 14 of uncoated steel mesh. In this embodiment the mesh sheet 14 has planar dimensions of 6 m×2.4 m. Those dimensions could be different in other applications employing the embodiment method. In Step 2, reference numeral 16, the mesh sheet 14 lies flat and is folded once to have planar dimensions of 3 m×2.4 m. Following folding in Step 2, the mesh sheet 14 is rotated and undergoes an initial welding process for jointing opposing sections of the mesh sheet following the folding of Step 2. This is Step 3 of the embodiment method and is indicated with the reference numeral 18.

In Step 4, reference numeral 20, the mesh sheet 14 is rotated to be vertically orientated whereafter welding of the mesh sheet 14 is completed. Following welding the mesh sheet 14 constitutes a mesh cage 22. During Step 4A, reference numeral 21, several vertically spaced apart non-illustrated round cooling conduits are secured to the mesh cage 22. Step 4A also includes that several non-illustrated electronic sensors (integrated circuit chips) be secured to the mesh cage 22. These sensors are adapted to measure temperature of curing concrete and can also be employed to measure stresses to which the completed concrete products are subjected. Several lifters are secured to the mesh cage 22 which can be employed during the process of transporting the formed concrete products. The process is repeated until fourteen mesh cages 22 have been formed. It is pointed out that the mesh cages 22 will provide the reinforcing of precast concrete products produced by the embodiment method. The mesh cages 22 are located within a non-illustrated cassette. The cassette is adapted to accommodate mass loading reinforcing (mesh cages) of variable length. The cassette ensures the mesh cages are held in an evenly spaced apart location.

In an alternative, non-illustrated, method of producing mesh cages, a custom sized mesh is provided by a mesh sheet fabricator. A second similar custom sized mesh sheet is overlaid to the first mesh sheet and secured thereto to produce a mesh cage. The mesh cage so formed is lifted into the cassette.

In Step 5, reference numeral 24, the fourteen mesh cages 22 held by the cassette are located inside a mould 26. The mould 26 is illustrated in FIGS. 2 to 4 and includes upright walls 30 strengthened with ribs 32. In this embodiment the walls 30 are produced from 40 mm steel plates. The mould 26 has an open top through which concrete will be poured to fill the mould 26. It is pointed out that upright wall 30.1 can be moved laterally to adjust the length of precast concrete product being produced. The walls 30.1 and 30.2 are removably secured to the side walls of the mould 26.

The mould 26 is provided with a manifold 34 which includes vertically spaced apart coupler and valve assemblies 36. In this embodiment the valves are ball valves, although other types of valves could also be used. With the mesh cages 22 located within the mould 26 Step 6, reference numeral 38, includes that the manifold 34 with its coupler and valve assemblies 36 be coupled to the non-illustrated cooling conduits supported by the mesh cages 22.

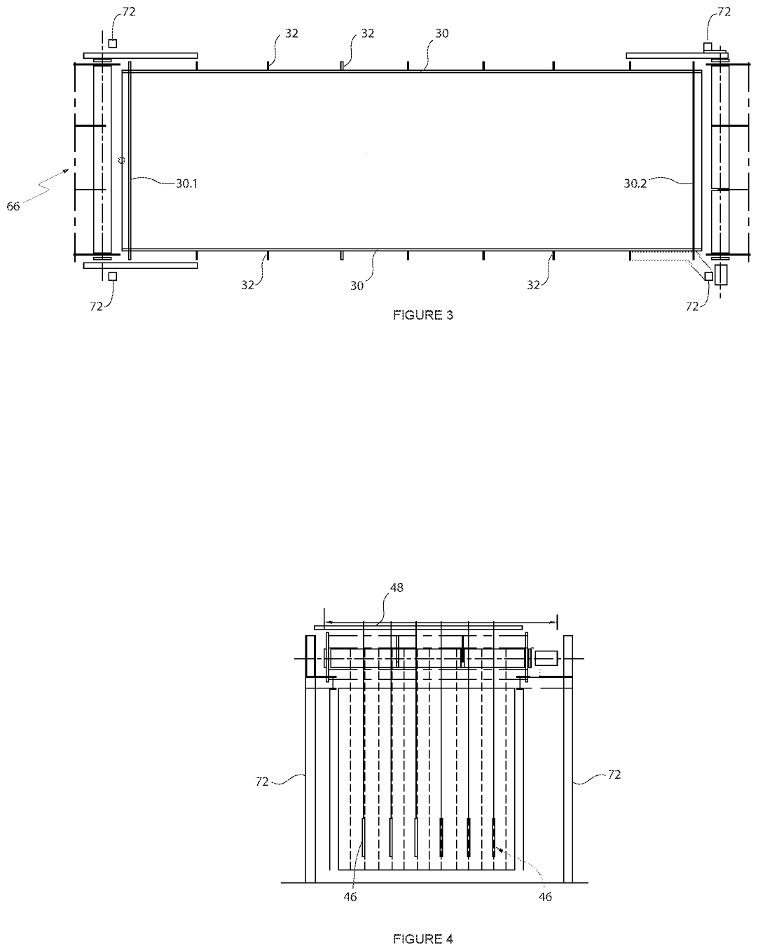

A concrete pump 40 is provided which is operatively associated with the mould 26. Step 7 includes preparing the concrete pump 40 for use in supplying concrete to the mould 26. In Step 8, reference numeral 44, concrete is poured into the mould 26 and the poured concrete vibrated/compacted. Referring to FIG. 4, vibration/compaction is effected with the use of vibrators 46 suspended from a horizontal beam 48. The vibrators 46 will be raised during concrete pour to ensure there are no cold joints. Typically, about 300-500 mm layers of concrete will be poured in the embodiment method. One of the sensors 50 on the mesh cages 22 is shown located within the mould 26. The sensor 50 is a temperature sensor and will feed temperature data to a temperature logging system 52. The fourteen mesh cages 22 located within the mould 26 will each include temperature sensors feeding temperature data to the temperature logging system 52.

Responsive to data obtained from the temperature sensors 50 the temperature logging system 52 will in Step 9, reference numeral 54, cause water to be injected into the cooling conduits of the mesh cages 22 via the coupler and valve assemblies 36. The water fed to the coupler and valve assemblies 36 are obtained from an ice reservoir 56 which will cool water prior to being injected into the coupler and valve assemblies 36. Water which have passed through the cooling conduits is returned to a reservoir 58. The reservoir 58 is temperature monitored by a reservoir temperature monitoring system generally indicated with the reference numeral 59. During Step 9 the top surface of the poured concrete will be subjected to a steel trowel finish. Step 9 may also include that a curing compound is sprayed to the poured concrete. Persons skilled in the art will appreciate that heat is generated during concrete curing and the need for cooling to ensure cured concrete of a good quality and statutory concrete and building code compliant.

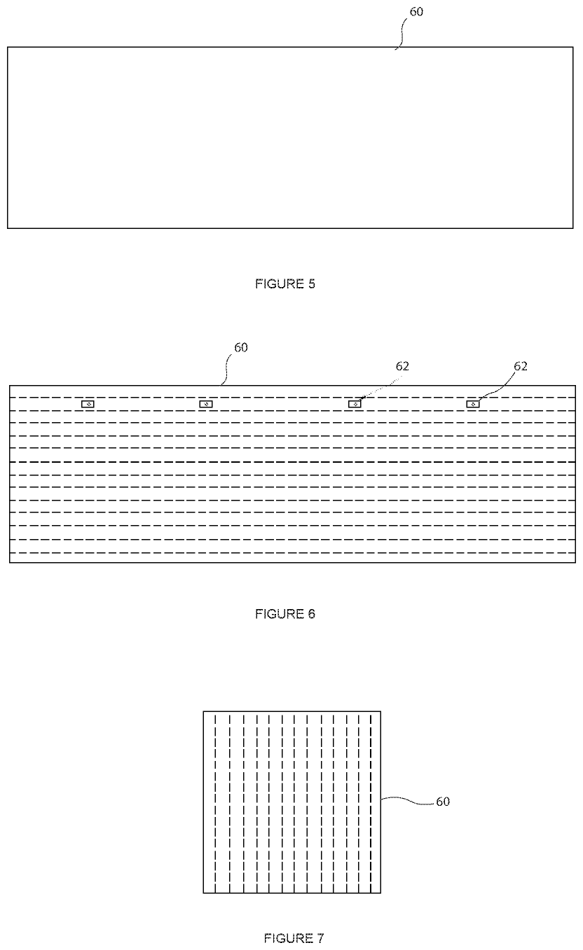

Following curing an oblong concrete body 60, shown in FIGS. 5 to 7 is obtained. The concrete body 60 includes various spaced apart cast-in lifters, four of which are shown and indicated with the reference numeral 62. Once the concrete body 60 has been cut into rectangular panels, as discussed below, the lifters 62 are employed for lifting the precast concrete panels from the mould 26.

Step 10, reference numeral 64, includes a cutting assembly, specifically a wire-cutting assembly 66, shown in FIGS. 5 to 7, employing diamond wire being set-up for use. The wire-cutting assembly 66 includes a first and second tower 68, 70. Each of the first and second towers 68, 70 include two upright posts 72. The first tower 68 supports a drive motor 74 of the wire-cutting assembly 66. The second tower 70 supports a tensioner assembly 76 which comprises several individual tensioners 78 for wire-cutters 80. The wire-cutting assembly 66 is attached to the posts 72 to enable vertical travel from Position A to Position B in FIG. 2. Such vertical travel enables the cutting assembly 66 to cut through the entire concrete body 60 located within the mould 26.

In Step 11, reference numeral 82, the end walls 30.1 and 30.2 and the non-illustrated cassette are removed from the mould 26 and the wire-cutting assembly 66 is activated. Upon activation the wire-cutters 80 will cut through the concrete body 60. The cutting step 82 will typically take about 8 hours. To effect cooling during the cutting step 82 water held within the reservoir 58 will be fed with non-illustrated conduits to be sprayed onto the wire-cutters 80 for cooling. Following completion of Step 11, several rectangular precast panels are obtained. Upon completion of cutting Step 11, the wire-cutting assembly 66 is raised and the wire-cutters 80 removed for future use.

Step 12, reference numeral 84, includes that individual formed precast concrete panels are lifted from the mould 26 and placed in vertical storage to be dispatched to a construction site. If required, panels so formed may undergo further CNC work in Step 13, reference numeral 89.

FIG. 8 diagrammatically illustrates a target surface finish 86. An embodiment concrete panel includes 40 mm graded river gravels 87 to produce an aesthetically pleasing sawn surface highlighting the full gravel size. For particular architectural specifications the surface can be a sawn or polished finish. Gravel in selected colours can also be used to provide architects with alternative design options. The same will apply in the case where concrete is replaced with a composite substance.

FIG. 9 illustrates a main foyer sign 88 in the form of a precast panel 90 produced by the embodiment method. The panel has undergone CNC machining to provide lettering 92. Several holes have been drilled through the panel 90 and house light emitting diodes (LEDs) 94 for creating lighting effects.

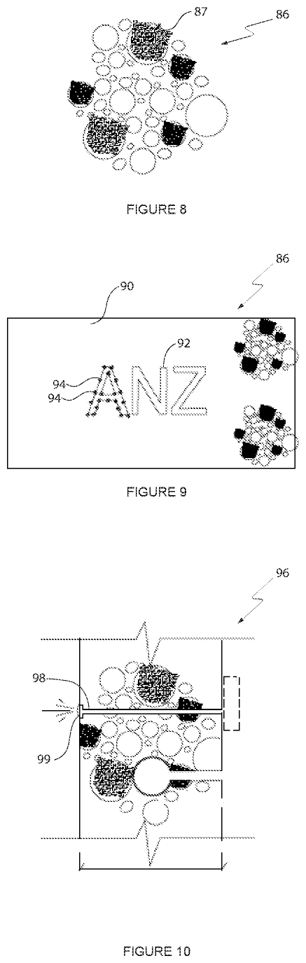

FIG. 10 shows a portion of a precast panel 96 obtained by the embodiment method. The cooling conduits of the panel 96 are employed for housing services such as electric cabling. The panel 96 further includes several CNC drilled holes 98 according to design specifications for holding LED or wall light points 99.

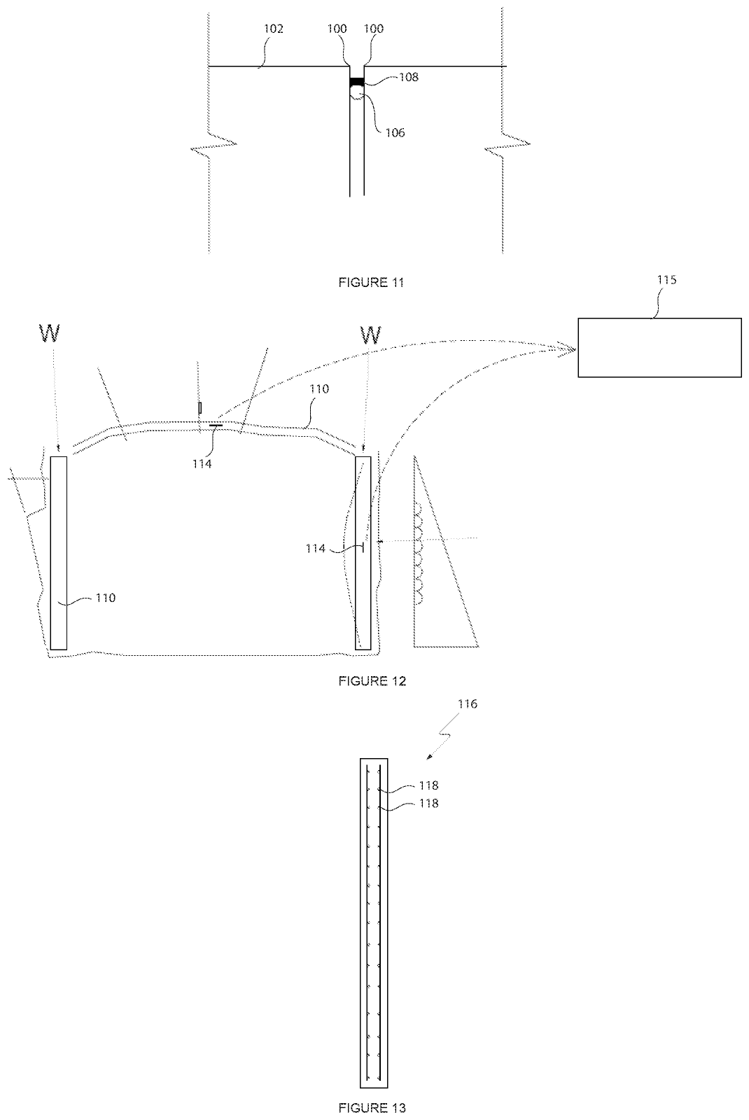

FIG. 11 illustrates that employing wire-cutting provides sharp edges 100 on a precast concrete panel 102. This is contrary to conventional precast panels which include chamfered edges. In is envisaged that such sharp edges could provide architects with a desired appearance as a sharp shadow line can break up the visual mass of a large panel wall. This sharp shadow line can be achieved with a standard backing rod 106 and flexible sealer 108.

In FIG. 12 precast concrete panels 110 produced by the embodiment method are used as structural lining at a mining entrance 112. The concrete panels 110 include sensors 114 which can capture temperature and vertical loading data and communicate the data to a control centre 115 for continuous monitoring temperate and load conditions within the portal and/or roof of a mine for safety purposes. Such monitoring can provide early warning of developing conditions within a mine portal and/or roof.

FIG. 13 shows a precast concrete panel 116 obtained by the embodiment method and including N12 reinforcing bars for enhanced strength. It is envisaged that precast concrete panels for mining applications can be produced in a range of thicknesses and heights as appropriate for the design of a specific mine. It is also envisaged that the face of such panels may be drilled with CNC machining to provide holes 118 for face-lifters as required.

In further non-illustrated embodiments building products produced by the method include pedestrian tunnels, retaining walls, grain bunkers and horse arenas and highway retaining walls.

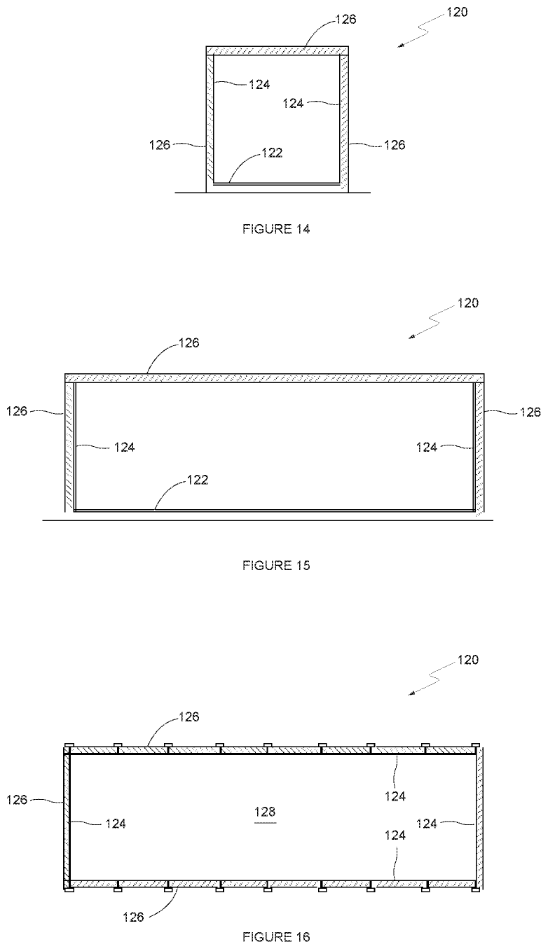

FIGS. 14 to 16 show a second embodiment mould 120 having a base 122 and upright walls 124 upwardly extending from the base 122. The mould 120 is insulated with insulation panels 126, here produced from styrofoam. FIG. 16 shows the mould 120 with an open top housing a concrete body 128. Once the top of the concrete body 128 has been screeded/finished the top of the mould 120 is closed off with an insulation panel 126.

Persons skilled in the art will be aware of the damaging consequences of delayed ettringite formation (DEF). DEF is the expansion and cracking of concrete associated with the delayed formation of ettringite. Ettringite is a normal product of early cement hydration. DEF in turn is the result of high early temperatures (above 70° C.-80° C.) in concrete which prevents the normal formation of ettringite. DEF can be prevented by limiting the internal concrete temperature to 70° C. during the early life of the concrete. By pouring concrete specified by a concrete technician which will deter DEF, for example due to reduced cement content or being low heat concrete, and by employing insulation panels 126 concrete can be moulded inside the mould 120 without the need of a the cooling conduit system as was the case with the first embodiment.

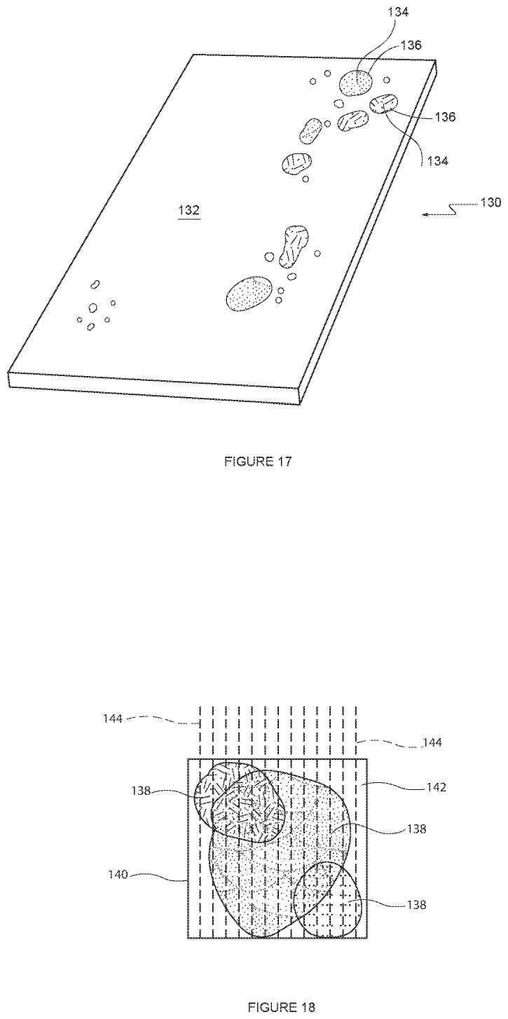

FIG. 17 shows an embodiment decorative concrete product 130. The decorative concrete product 130 includes a concrete panel 132 having decorative elements/wafers 134. The decorative elements 134 are located within recesses 136 which have been custom cut in the concrete panel 134 via a CNC process to conform to the shape/profile of a specific decorative element 134. It is envisaged that the decorative concrete product 130 could be employed as floor slabs or vertical wall slabs.

The decorative elements 134 are produced by locating riverbed rocks 138 within a mould 140 and pouring concrete into the mould 140. The concrete is allowed to set to form a concrete body 142 having riverbed rocks embedded therein. The concrete body 142 is hereafter cut into non-illustrated panels with a diamond saw machine. The cuts are represented by broken lines 144 having a wire. Finally, concrete is removed from the riverbed portions of the panels to provide the decorative elements/wafers 134. It is envisaged that the decorative elements 134 could undergo a polishing step.

Although the invention has been described with reference to specific examples, it will be appreciated by those skilled in the art that the invention may be embodied in many other forms.

### KEY TO REFERENCE NUMERALS

10 Method of producing precast building products
12 Step 1
14 Sheet
16 Step 2
18 Step 3
20 Step 4
21 Step 4A
22 Mesh cage
24 Step 5
26 Mould
30 Upright walls
30.1 Upright wall
30.2 Upright wall
32 Ribs
34 Manifold
36 Coupler and valve assemblies
38 Step 6
40 Concrete pump
42 Step 7
44 Step 8
46 Vibrators
48 Horizontal beam
50 Sensors
52 Temperature logging system
54 Step 9
56 Ice reservoir
58 Reservoir
60 Concrete body
62 Cast-in lifters
64 Step 10
66 Wire-cutting assembly
68 First tower
70 Second tower
72 Upright posts
74 Drive motor
76 Tensioner assembly
78 Individual tensioners
80 Wire-cutters
82 Step 11
84 Step 12
86 Target finish
87 River gravels
88 Foyer sign
89 Step 13
90 Precast panel
92 Lettering
94 LEDs
96 Precast panel
98 Drilled holes
99 Light points
100 Sharp edges
102 Concrete panel
106 Backing rod
108 Flexible sealer
110 Concrete panels
112 Mining entrance
114 Sensors
116 Concrete panel
118 Holes
120 Second embodiment mould
122 Base
124 Upright walls
126 Insulation panels
128 Concrete body
130 Decorative concrete product
132 Concrete panel
134 Decorative elements/wafers
136 Recess
138 Riverbed rock
140 Mould
142 Concrete body
144 Wire saw cuts

1. A method of producing a precast building product, the method including the steps of:
providing a mould to receive a pourable building substance to be cured;
pouring the building substance into the mould;
allowing the poured building substance to cure inside the mould to form a sold mass body;
providing a wire-cutting assembly operatively associated with the mould; and
cutting the solid mass body inside the mould into separate building products.

2. A method according to claim 1, including the step of vibrating the poured building substance.

3. A method according to claim 2, including the step of locating reinforcing within the mould prior to the step of pouring the building substance into the mould.

4. A method according to claim 3, wherein the reinforcing comprises a plurality of mesh cages.

5. A method according to claim 4, wherein the mesh cages have at least one electronic sensor attached thereto.

6. A method according to claim 3, wherein the reinforcing supports a plurality of elongate cooling conduits.

7. A method according to claim 6, including the step of suppling cooling liquid through the conduits.

8. A method according to claim 1, including the step of insulating the mould.

9. (canceled)

10. A method according to claim 1, wherein the building substance is selected from the group consisting of concrete and a building composite that includes gravels.

11. A method according to claim 2, wherein the building substance is selected from the group consisting of concrete and a building composite that includes gravels.

12. A method according to claim 3, wherein the building substance is selected from the group consisting of concrete and a building composite that includes gravels.

13. A method according to claim 4, wherein the building substance is selected from the group consisting of concrete and a building composite that includes gravels.

14. A method according to claim 5, wherein the building substance is selected from the group consisting of concrete and a building composite that includes gravels.

15. A method according to claim 6, wherein the building substance is selected from the group consisting of concrete and a building composite that includes gravels.

16. A method according to claim 7, wherein the building substance is selected from the group consisting of concrete and a building composite that includes gravels.

17. A method according to claim 8, wherein the building substance is selected from the group consisting of concrete and a building composite that includes gravels.
